(19) United States
(12) Patent Application Publication
(10) Pub. No.: US 2003/0006572 A1
(43) Pub. Date: Jan. 9, 2003

(54) Suitcase shockproof caster structure

(76) Inventor: Chiung-Chu Huang, Feng-Yuan City (TW)

Correspondence Address: CHIUNG-CHU HUANG, P.O. Box 697, Feng-Yuan City 420, TW

(21) Appl. No.: 09/900,118

(22) Filed: Jul. 5, 2001

(51) Int. Cl. B62B 5/00; A47B 91/00

(52) U.S. Cl. 280/79.11; 16/44

(57) ABSTRACT

The present invention of a suitcase shockproof caster structure includes a caster chassis which is connected to a caster cap on one side, a caster is connected to the caster cap on the other side. An elastic pad and a rod are disposed underneath the inner side of the caster chassis, the rod goes through the elastic pad and is sleeved by a spring. A U-shaped elastic plate having a flat end, a bent end and a bottom pointed end, the flat end is connected to the caster chassis while the spring is disposed above the upper side of the bottom pointed end of the U-shaped elastic plat. Accordingly, the U-shaped elastic plate acts as the main shock and vibration absorption element, while the spring provides a means of absorption when the caster chassis is under a greater pressure.

### BACKGROUND OF THE INVENTION

The present invention relates to suitcase caster and more particularly to a suitcase shockproof caster structure. Conventional suitcase employs casters to roll on ground and to support weight. Shock and vibration transmitted to user's hand makes it uncomfortable and might cause injury to wrist. Some suitcases use coil type spring to absorb shock and vibration, but suitcases have different weight, the heavier the weight is, the thicker the coil spring needed to be used. Due to its thickness, the coil spring loses its elasticity to absorb shock and vibration.

### SUMMARY OF THE PRESENT INVENTION

The present invention of a suitcase shockproof caster structure includes a caster chassis and a caster cap, the caster cap is enclosed by the caster chassis on the same center axes, and the caster cap is a sectional U-shaped body which encloses a caster on the same center axes. A rod is protruded downward from the inner side of the caster chassis, a spring is enclosed on the rod. A roughly U-shaped elastic plate with a flat end is connected underneath the inner side of the caster chassis by a rivet, the pointed U-shaped end of the U-shaped elastic plate is facing downward in contact with the top of the caster cap. Accordingly, the U-shaped elastic plate is used to absorb shock and vibration transmitted to the caster chassis. When the caster chassis has to support larger weight, the U-shaped elastic plate presses against the spring to efficiently reduce shock and vibration.

The present invention has a primary objective to provide multiple shock and vibration proof structures formed by combination of many shock and vibration proof elements. As a result, shock and vibration is greatly reduced to the minimum no matter how heavy or light the suitcase may be.

The present invention will become more fully understood by reference to the following detailed description thereof when read in conjunction with the attached drawings.

### BRIEF DESCRIPTION OF THE DRAWINGS

FIG. 1 is an exploded perspective view of the present invention of a suitcase shockproof caster structure,

FIG. 2 is an assembly perspective view of the present invention of a suitcase shockproof caster structure,

FIG. 3 is an assembly perspective view of the present invention of a suitcase shockproof caster structure when installed on a suitcase,

FIG. 4 is a sectional view of FIG. 2 on plane 4-4,

FIG. 5 is a flat view of the present invention of a suitcase shockproof caster structure,

FIG. 6 is a sectional view of FIG. 2 on plane 6-6,

FIG. 7 is a sectional view of the present invention of a suitcase shockproof caster structure when a caster cap presses against a U-shaped elastic plate, and

FIG. 8 is a sectional view of the present invention of a suitcase shockproof caster structure when a spring is being pressed.

### DETAILED DESCRIPTION OF THE PREFERRED EMBODIMENT

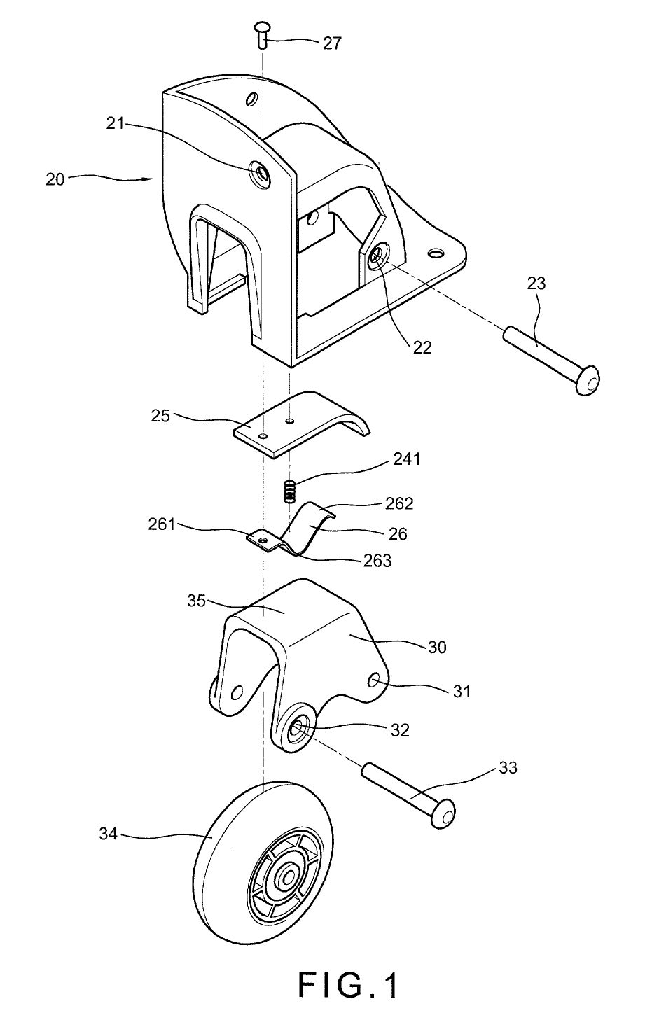

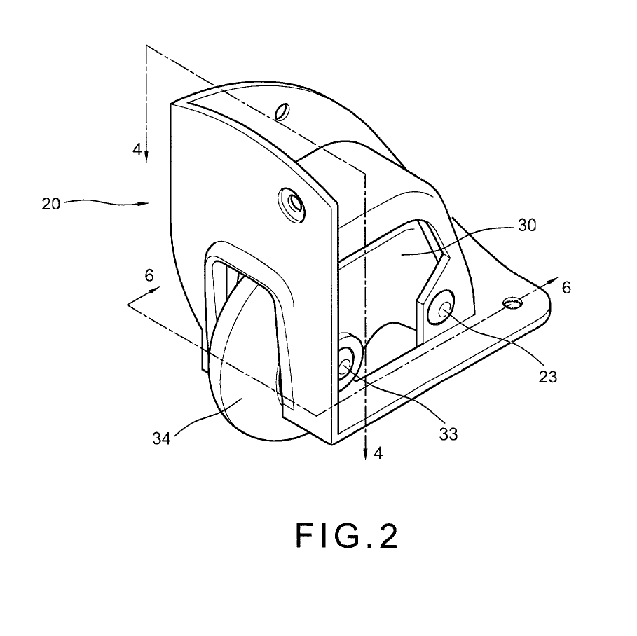

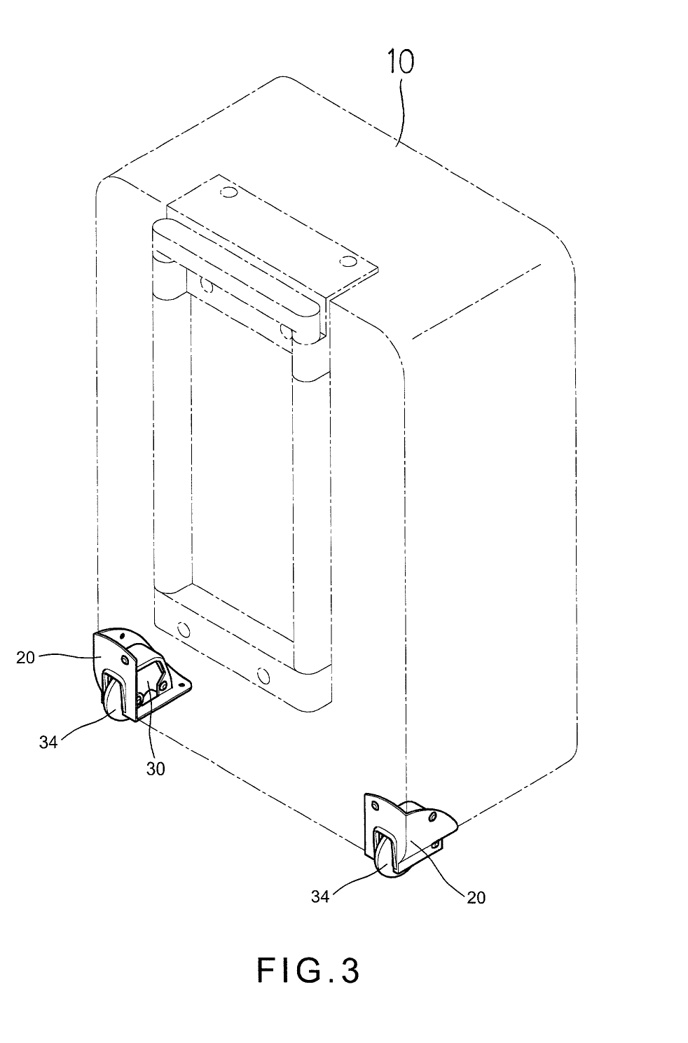

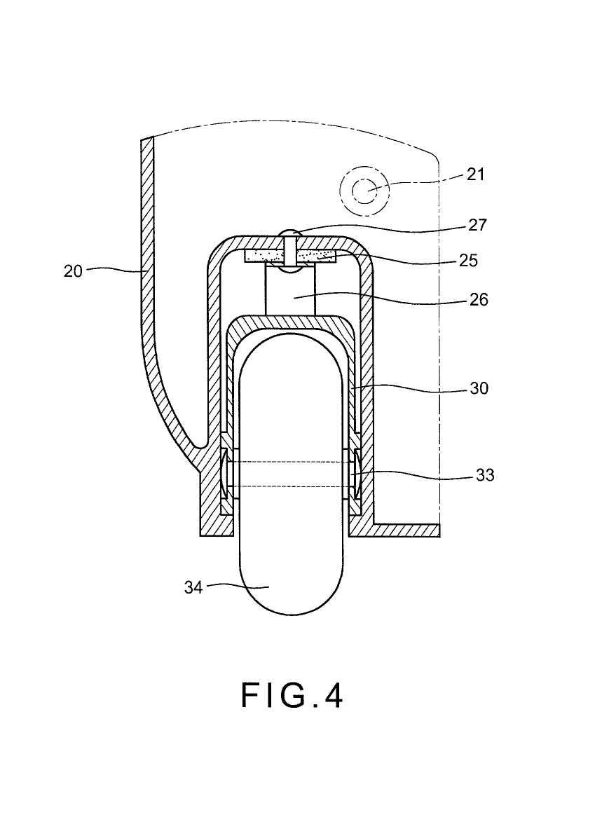

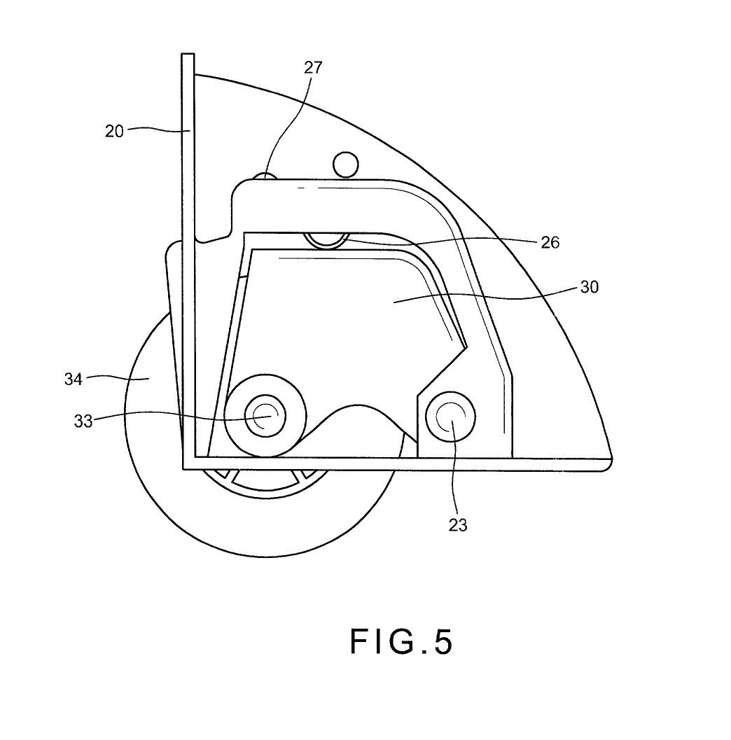

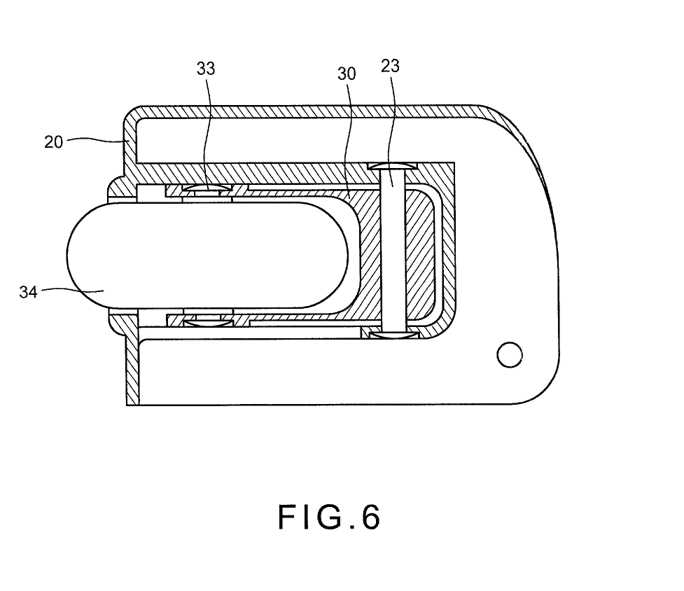

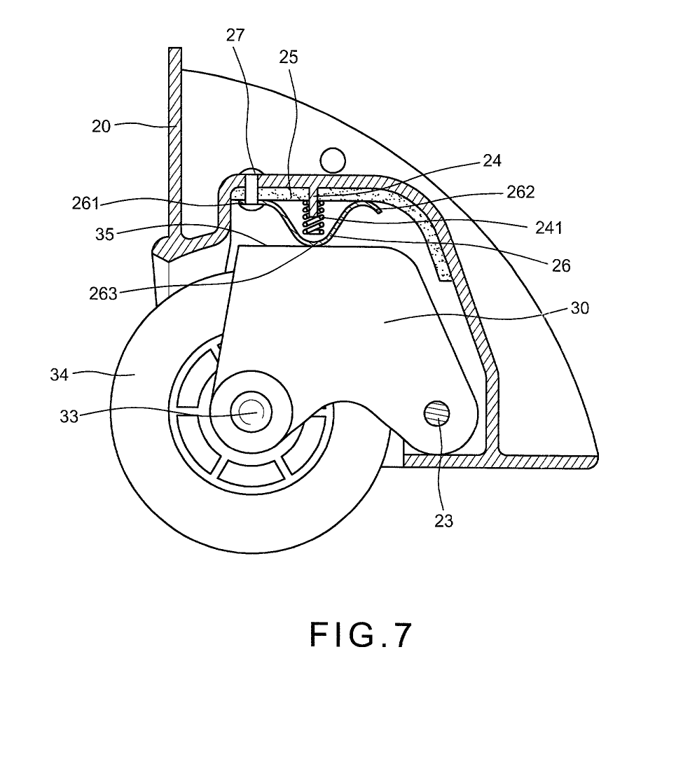

The present invention of a suitcase shockproof caster structure, with reference to FIGS. 1 to 6, a caster chassis 20 is installed on a suitcase 10 through a plurality of holes 21 for fixing at the corners of the suitcase 10. A pair of fixing holes 22 corresponding to each other are disposed on the caster chassis 20. A pair of fixing holes 31 corresponding to each other are disposed at one of the lower corners on a caster cap 30. A rivet 23 goes through the fixing holes 22 of the caster chassis 20 and the fixing holes 31 of the caster cap 30. Another pair of fixing holes 32 corresponding to each other are disposed at the other lower corner on the caster cap 30. A rivet 33 is used to go through the fixing holes 32 and a caster 34 to connect the caster cap 30 and the caster 34 together. As shown in FIG. 7, a rod 24 is disposed underneath the inner side of the caster chassis 20, an elastic pad 25 is placed on the inner side of the caster chassis 20. The rod 24 goes through the elastic pad 25 and is sleeved by a spring 241. A roughly U-shaped elastic plate 26 with one flat end 261 and another slightly bent end 262 is disposed right underneath the rod 24. A rivet 27 is employed to connect the elastic pad 25 and the U-shaped elastic plate 26 together, the flat end 261 of the U-shaped elastic plate 26 provide flat surfaces for the rivet 27 to go through. The bent end 262 of the U-shaped elastic plate 26 being bended downward presses against the elastic pad 25. A bottom pointer end 263 of the U-shaped elastic plate 26 presses against a top surface 35 of the caster cap 30.

Accordingly, first fix the elastic pad 25 underneath the inner side of the caster chassis 20, sleeve the spring 241 on the rod 24, then employ the rivet 27 to fix the U-shaped elastic plate 26 on the flat end 261. Connect the caster 34 to the caster cap 30 through the fixing holes 32 by the rivet 33, then fix the caster cap 30 underneath the caster chassis 20 through the fixing holes 22 by means of the rivet 23. Thus the caster cap 30 is connected to the caster chassis 20 at one side by the rivet 23, while the top surface 35 of the caster cap 30 will make contact or depart from the bottom pointer end 263 of the U-shaped elastic plate 26, depending on the weight of the suitcase 10. When the U-shaped elastic plate 26 is being pressed, the flat end 261 remains in its position while the bent end 262 presses against the elastic pad 25 to absorb shock and vibration.

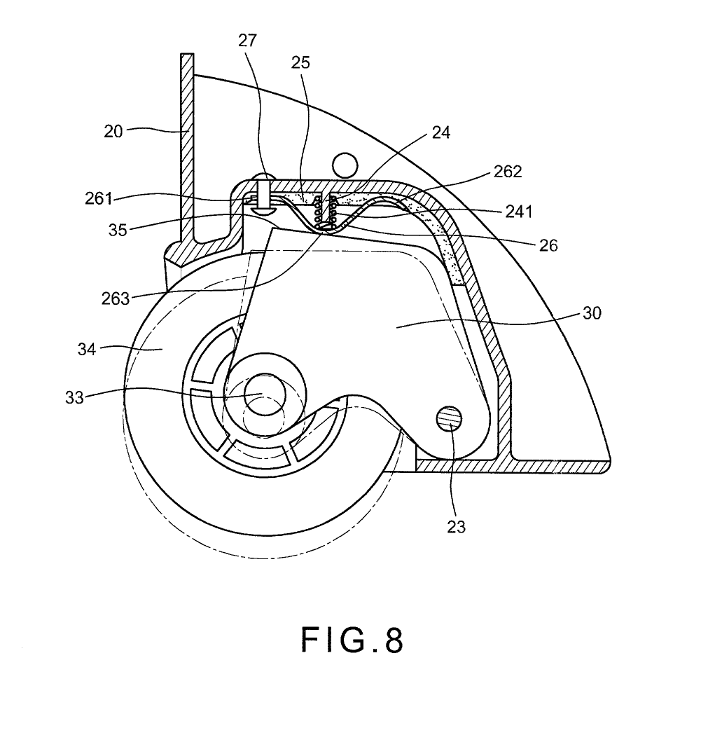

Referring to FIG. 8, if the suitcase 10 is heavy in weight, it causes the U-shaped elastic plate 26 to bend even curvier, so that the upper side of the bottom pointed end 263 presses against the spring 241 which can absorb shock and vibration. Combination structure of the U-shaped elastic plate 26, spring 241 and the elastic pad 25 provides a means of triple shock and vibration absorption effect, and is suitable for both light and heavy suitcase 10. The elastic pad 25 acts as the last shock and vibration absorption element if the U-shaped elastic plate 26 and the spring 241 suffer sudden pressure.

Furthermore, the bent end 262 of the U-shaped elastic plate provides a buffer zone between the elastic pad 256 for absorbing sudden shock and vibration.

The specification relating to the above embodiment should be construed as exemplary rather than as limitative of the present invention, with many variations and modifications being readily attainable by a person of average skill in the art without departing from the spirit or scope thereof as defined by the appended claims and their legal equivalents.

I claim:

1. A suitcase shockproof caster structure comprising:
a caster chassis and a caster cap, said caster cap is enclosed inside said caster chassis, said caster cap is an upside down sectional U-shaped body, a caster is enclosed inside said caster cap, a rod is protruded downward underneath the inner side of said caster chassis, a spring is sleeved on said rod, a rivet is employed to fix an U-shaped elastic plate on its flat end underneath said caster chassis, said U-shaped elastic plate having another bent end being bended downward, a bottom pointed end of said U-shaped elastic plate is for pressing against a top surface of said caster cap, accordingly, said U-shaped elastic plate acts as a main shock and vibration element, said spring will be pressed against said U-shaped elastic plate and thus provides further shock and vibration effect when said caster chassis is under greater pressure.

2. A suitcase shockproof caster structure as claimed in claim 1, an elastic pad is fixed underneath the inner side of said caster chassis, it acts as a buffer element for said spring and said bent end of said U-shaped elastic plate to press against.
